(19) United States
(12) Patent Application Publication
(10) Pub. No.: US 2026/0131763 A1
(43) Pub. Date: May 14, 2026

(54) Vehicle Washing Machine

(71) Applicant: YIGOLI TECHNOLOGY (HONG KONG) LIMITED, Hong Kong (HK)

(72) Inventor: Hengzhi Shi, Hong Kong (HK)

(21) Appl. No.: 19/444,272

(22) Filed: Jan. 9, 2026

(51) Int. Cl. B60S 3/04; B08B 3/02; B08B 13/00

(52) U.S. Cl. CPC B60S 3/04; B08B 3/024; B08B 13/00

(57) ABSTRACT

Provided is a vehicle washing machine. The vehicle washing machine includes a traveling cantilever device and a nozzle component. The nozzle component includes a horizontal rotation drive device, a water nozzle, and a detergent nozzle. A horizontal rotation frame is connected to the horizontal rotation drive device. A pitch drive electric motor is arranged on the horizontal rotation frame. A pitch shaft is arranged on the pitch drive electric motor. A first pitch frame assembly and a second pitch frame assembly are arranged on the pitch shaft. An electrically-controlled switching valve is arranged on the first pitch frame assembly. An output end of the electrically-controlled switching valve is connected to a first water outlet pipe and a second water outlet pipe. A water nozzle support is arranged on the second pitch frame assembly. A second hoop is arranged on the water nozzle support.

### FIELD OF INVENTION

The present disclosure relates to the field of vehicle maintenance apparatuses, and particularly relates to a vehicle washing machine.

### DESCRIPTION OF RELATED ARTS

In the entire structure of a cantilever-type vehicle washing machine, a nozzle component is a core part for ensuring washing effects. This component typically integrates a water nozzle and a detergent nozzle, enabling the simultaneous dual functions of high-pressure water spraying washing and foam spraying cleaning, thereby efficiently achieving comprehensive cleaning of a vehicle body. To satisfy the cleaning requirements of different vehicle models and various parts of the vehicle body, the detergent nozzle and the water nozzle are jointly mounted on a platform capable of horizontal rotation and pitch adjustment. Driven by this platform, the nozzles can realize flexible adjustment of spraying angles and positions, to ensure complete cleaning without missed areas. However, during long-term practical use, the water nozzle and the detergent nozzle are prone to wear, clog or break due to high-frequency operation, requiring regular maintenance or replacement. In designs of conventional nozzle components, the convenience of disassembly and assembly of the water nozzle and the detergent nozzle are generally not adequately considered. They are complex in connecting structures and complicated in fixing methods, resulting in laborious mounting and disassembly of the water nozzle and the detergent nozzle. Difficulties in maintenance and replacement are immensely increased.

### SUMMARY OF THE PRESENT INVENTION

An objective of the present disclosure is to provide a vehicle washing machine, to overcome the defects in the prior art.

The objective of the present disclosure is achieved through a technical solution as follows: a vehicle washing machine includes a traveling cantilever device and a nozzle component mounted on the traveling cantilever device. The nozzle component includes a horizontal rotation drive device, a water nozzle, and a detergent nozzle. A horizontal rotation frame is connected to the horizontal rotation drive device. A pitch drive electric motor is arranged on the horizontal rotation frame. A pitch shaft is arranged on the pitch drive electric motor. A first pitch frame assembly and a second pitch frame assembly are arranged on the pitch shaft. An electrically-controlled switching valve is arranged on the first pitch frame assembly. An output end of the electrically-controlled switching valve is connected to a first water outlet pipe and a second water outlet pipe. A water nozzle support is arranged on the second pitch frame assembly. A second hoop for fixing the water nozzle is arranged on the water nozzle support. The water nozzle is connected to the first water outlet pipe. A detergent nozzle supporting plate is arranged on the water nozzle support. A snap-fit groove is arranged on the detergent nozzle supporting plate. A protruding portion is arranged on an outer side of the detergent nozzle, and is snap-fitted into the snap-fit groove on the detergent nozzle supporting plate. One end of the detergent nozzle is connected to the second water outlet pipe. The second water outlet pipe is a rigid pipe.

Preferably, a camera is arranged on the second pitch frame assembly.

Preferably, a camera mounting seat for mounting the camera is arranged on the second pitch frame assembly. The camera is mounted on and connected to the camera mounting seat by a screw.

Preferably, a first hoop and an electrically-controlled switching valve fixing support are arranged on the first pitch frame assembly. The electrically-controlled switching valve is connected to the first hoop. The electrically-controlled switching valve is connected to the electrically-controlled switching valve fixing support by a screw.

Preferably, the output end of the electrically-controlled switching valve is connected to a water inlet pipe. The water inlet pipe is connected to a water supply pipe. A detergent connector is arranged on a side of the detergent nozzle. The detergent connector is connected to a detergent pipe.

Preferably, the snap-fit groove is a U-shaped groove. An opening of the snap-fit groove faces a front side of the detergent nozzle.

Preferably, the traveling cantilever device includes two parallel guide rails, a traveling component mounted on the two guide rails, and a cantilever. The traveling component includes a traveling base. A first wheel shaft and a second wheel shaft are arranged on the traveling base. A first upper traveling wheel is arranged at one end of each of the first wheel shaft and the second wheel shaft. A second upper traveling wheel is arranged at the other end of each of the first wheel shaft and the second wheel shaft. The first upper traveling wheel is located on an upper side of one guide rail. The second upper traveling wheel is located on an upper side of the other guide rail. Rim structures are arranged on two sides of the first upper traveling wheel. The guide rail is located between the rim structures on the two sides of the first upper traveling wheel. Lower restraining wheels are arranged on the traveling base. The lower restraining wheels are located on lower sides of the two guide rails. A traveling drive device is arranged on the traveling base for driving the first wheel shaft and the second wheel shaft to rotate. A rotation drive device is arranged on the traveling base. The rotation drive device is connected to the cantilever. The nozzle component is arranged at an end portion of the cantilever.

Preferably, the traveling drive device is a speed-reduction electric motor. The first wheel shaft is connected to the speed-reduction electric motor. The first wheel shaft is connected to the second wheel shaft by a synchronous belt.

Preferably, the cantilever includes a supporting framework. A housing is arranged on an outer side of the supporting framework. One end of the supporting framework is connected to the rotation drive device. A passing space for a cable and a pipeline to pass through is formed between the housing and the supporting framework.

Preferably, the housing includes a first housing assembly and a second housing assembly. The first housing assembly is connected to the second housing assembly by a snap-fit mechanism. Connecting portions are arranged on an upper side and a lower side of the first housing assembly. Connecting holes are provided on the connecting portions. The connecting portions are connected to the supporting framework by connecting bolts.

Beneficial effects of the present disclosure are as follows: according to the present disclosure, the convenience of disassembly and assembly of the water nozzle and the detergent nozzle is adequately considered. The water nozzle is fixedly mounted by the hoop. The detergent nozzle is fixedly mounted by the rigid second water outlet pipe in combination with the snap-fit groove connection. Thus, the mounting and disassembly of the water nozzle and the detergent nozzle are greatly facilitated, and difficulties in maintenance and replacement of the nozzles are reduced.

### BRIEF DESCRIPTION OF THE DRAWINGS

FIG. 1 is a schematic structural diagram in one direction according to the present disclosure;

FIG. 2 is a schematic structural diagram in another direction according to the present disclosure;

FIG. 3 is a schematic structural diagram of a traveling component in one direction;

FIG. 4 is a schematic structural diagram of a traveling component in another direction;

FIG. 5 is a schematic structural diagram of a cantilever;

FIG. 6 is a schematic structural diagram of a cantilever with a second housing assembly removed;

FIG. 7 is a schematic structural diagram of a housing;

FIG. 8 is a schematic structural diagram of a first housing assembly;

FIG. 9 is a schematic structural diagram of a second housing assembly;

FIG. 10 is a schematic structural diagram of a nozzle component;

FIG. 11 is a schematic structural diagram, in one direction, of a nozzle component with a first housing and a second housing removed;

FIG. 12 is a schematic structural diagram, in another direction, of a nozzle component with a first housing and a second housing removed;

FIG. 13 is a schematic structural diagram of a pitch frame assembly;

FIG. 14 is a schematic structural diagram in one direction in a case that a detergent nozzle, a water nozzle, a camera, and an electrically-controlled switching valve are mounted on a pitch frame assembly; and

FIG. 15 is a schematic structural diagram in another direction in a case that a detergent nozzle, a water nozzle, a camera, and an electrically-controlled switching valve are mounted on a pitch frame assembly.

In the figures: 1. guide rail, 2. cantilever, 2-1. supporting framework, 2-2. first housing assembly, 2-2a. connecting portion, 2-2b. first snap-fit body, 2-3. second housing assembly, 2-3a. second snap-fit body, 2-4. connecting bolt, 3. protective cover, 4. traveling base, 5. traveling drive device, 6. first wheel shaft, 7. second wheel shaft, 8. synchronous belt, 9. first upper traveling wheel, 10. second upper traveling wheel, 11. rotation drive device, 12. lower restraining wheel, 13. nozzle component, 13-1. first housing, 13-2. second housing, 13-3. water supply pipe, 13-4. detergent pipe, 13-5. water nozzle, 13-6. detergent nozzle, 13-7. camera, 13-8. horizontal rotation drive device, 13-9. water inlet pipe, 13-10. horizontal rotation frame, 13-11. electrically-controlled switching valve, 13-12. pitch drive electric motor, 13-13. pitch shaft, 13-14. first pitch frame assembly, 13-15. second pitch frame assembly, 13-16. first hoop, 13-17. electrically-controlled switching valve fixing support, 13-18. connecting column, 13-19. water nozzle support, 13-20. second hoop, 13-21. detergent nozzle supporting plate, 13-22. camera mounting seat, 13-24. first water outlet pipe, 13-25. second water outlet pipe, 13-26. protruding portion, and 13-27. detergent connector.

### DETAILED DESCRIPTION OF THE PREFERRED EMBODIMENT

The technical solutions of the embodiments of the present disclosure are clearly and completely described below in combination with the accompanying drawings. Apparently, the described embodiments are merely some rather than all embodiments of the present disclosure. All other embodiments derived by a person of ordinary skill in the art based on the embodiments of the present disclosure all fall within the scope of protection of the present disclosure.

A person skilled in the art should understand that in the present disclosure, the orientational or positional relations indicated by the terms “longitudinal”, “transverse”, “upper”, “lower”, “front”, “rear”, “left”, “right”, “vertical”, “horizontal”, “top”, “bottom”, “inner”, “outer”, etc. indicate orientational or positional relations based on those shown in the accompanying drawings. These terms are used only for ease of description of the present disclosure and for simplicity of the description, and do not indicate or imply that the indicated apparatus or element must have a particular orientation and be constructed and operated in a particular orientation. Thus, the above terms cannot be construed as a limitation on the present disclosure.

It can be understood that the term “one” should be interpreted as “at least one” or “one or more”. That is, the number of an element may be one in one embodiment, while the number of the element may be multiple in another embodiment. The term “one” cannot be interpreted as limiting the number.

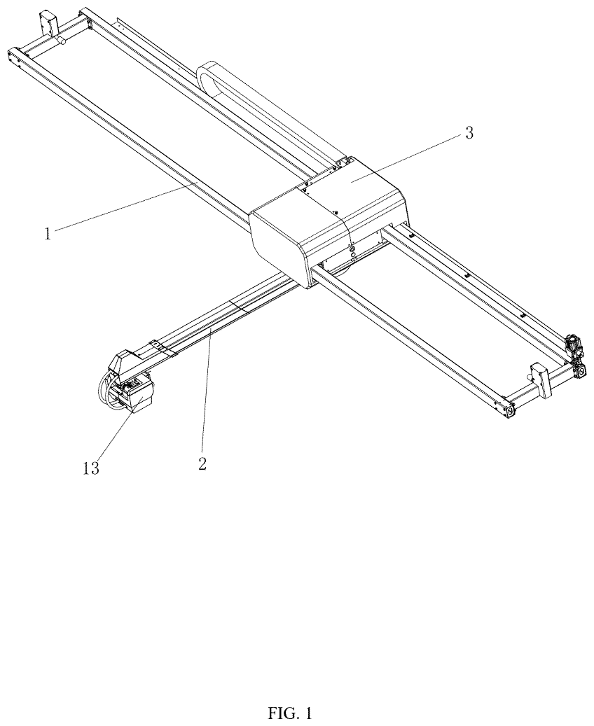

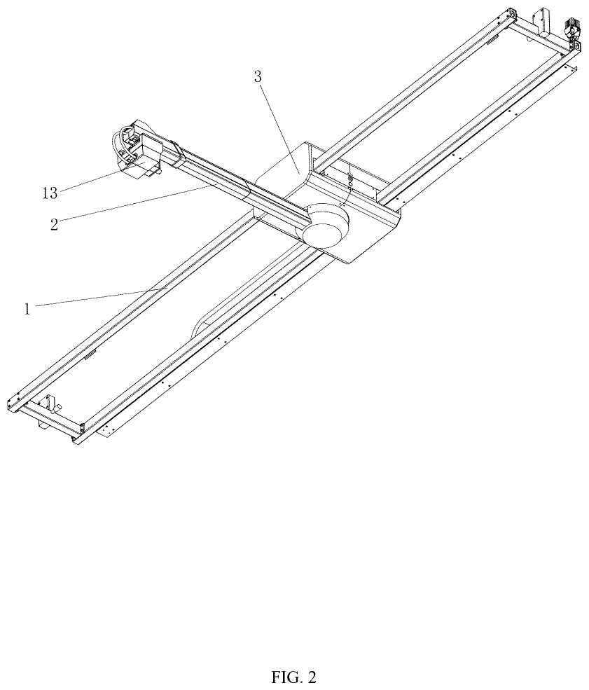

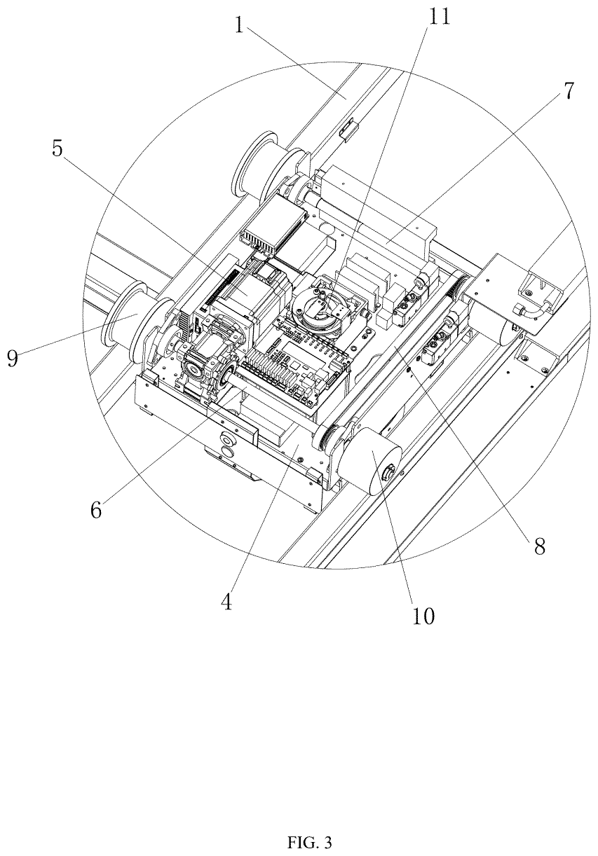

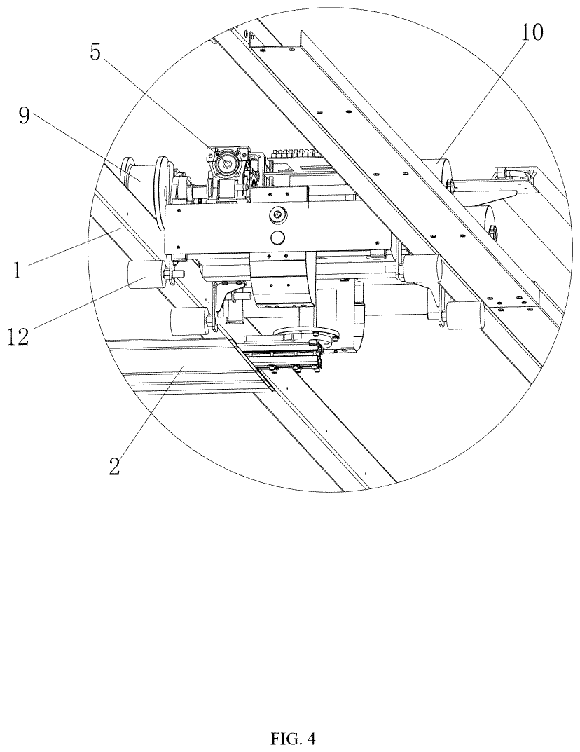

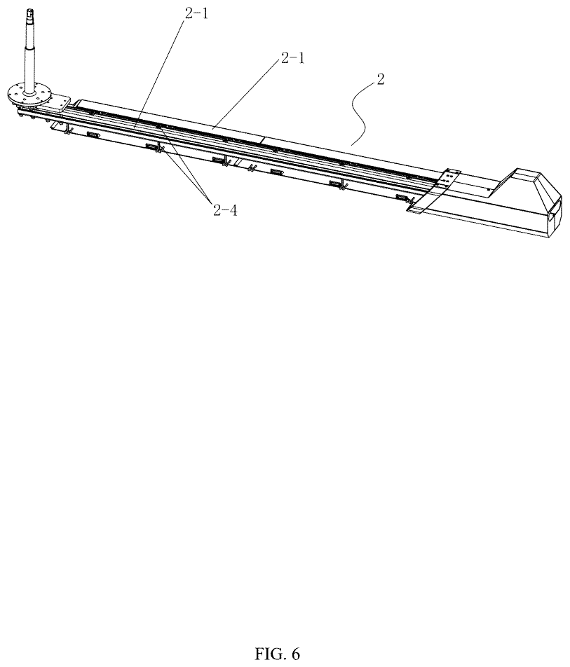

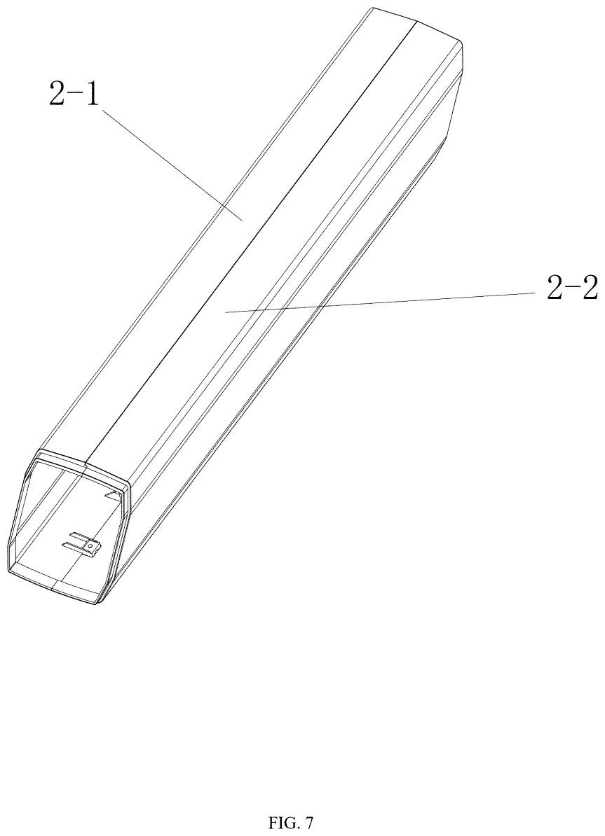

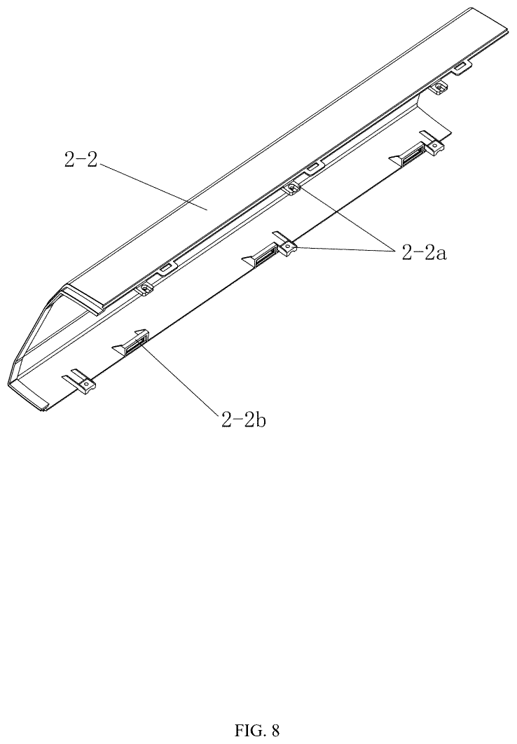

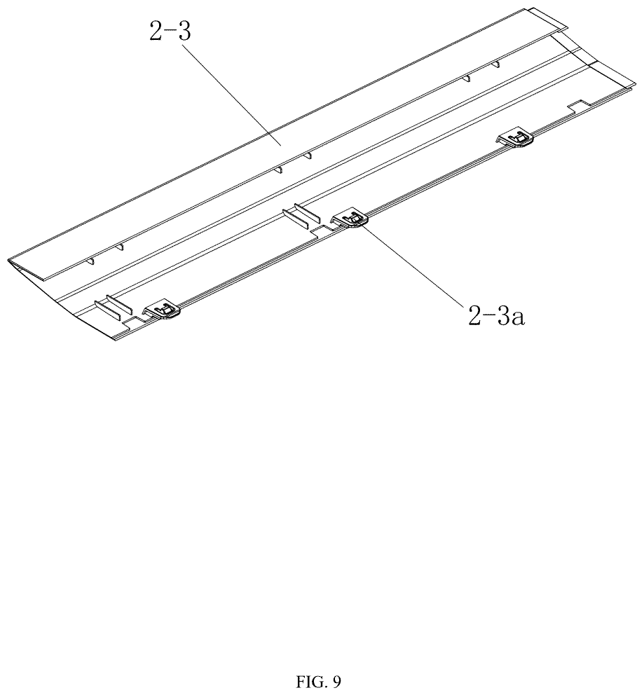

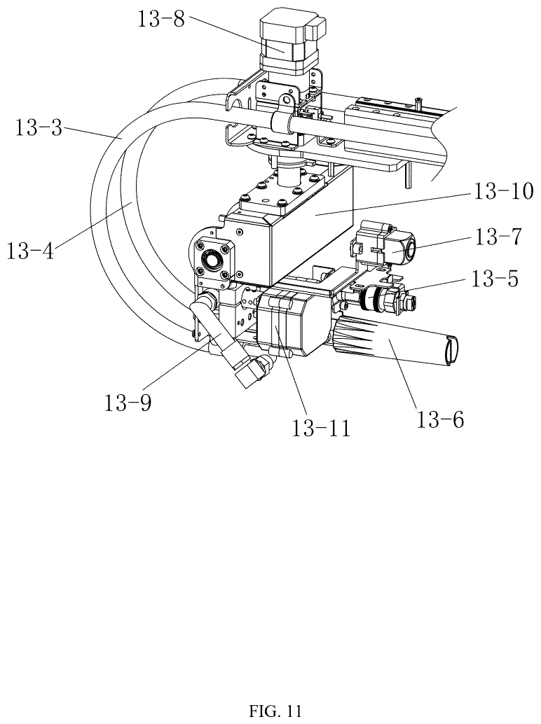

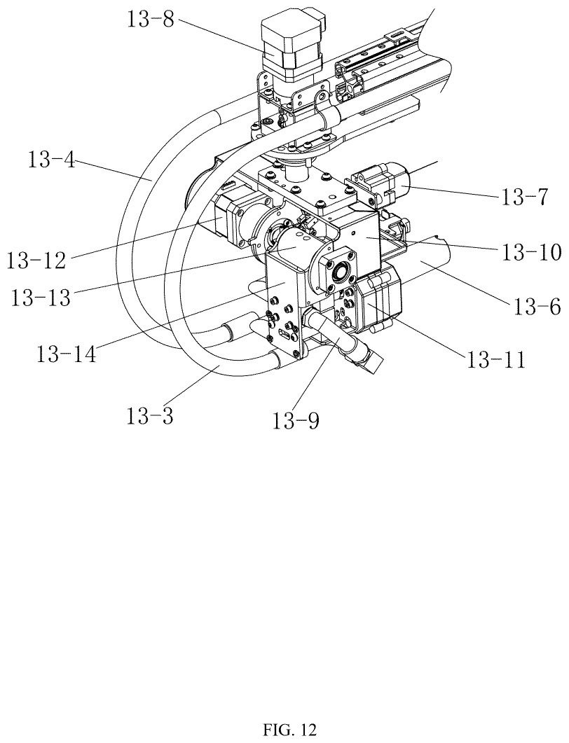

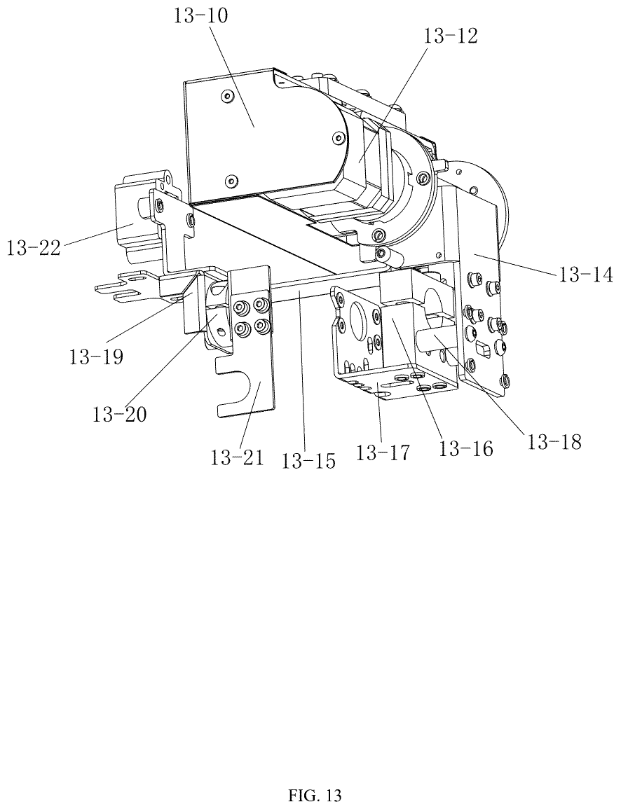

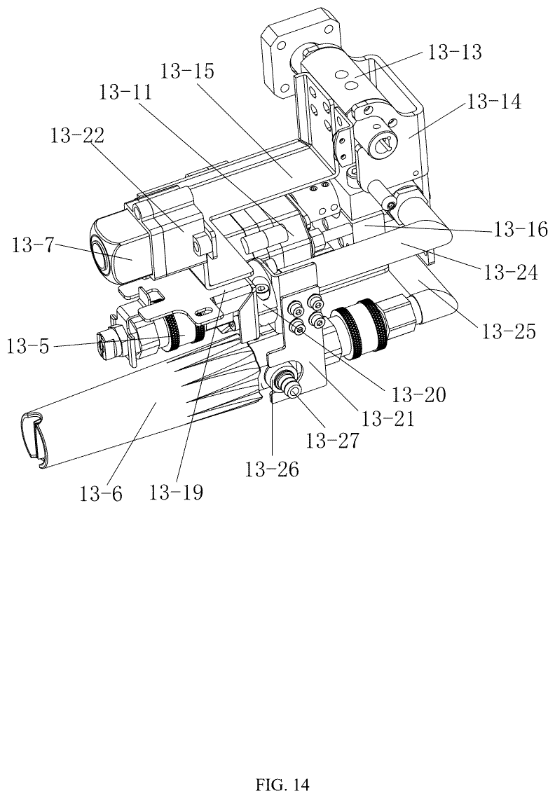

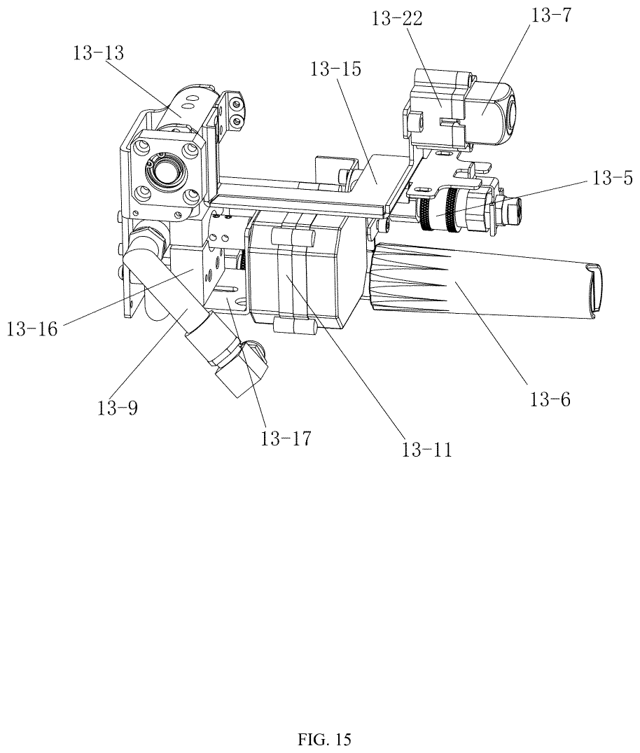

As shown in FIG. 1 to FIG. 15, a vehicle washing machine includes a traveling cantilever device and a nozzle component 13 mounted on the traveling cantilever device.

As shown in FIG. 1 to FIG. 9, the traveling cantilever device includes two parallel guide rails 1, a traveling component mounted on the two guide rails 1, and a cantilever. The traveling component includes a traveling base 4. A first wheel shaft 6 and a second wheel shaft 7 are arranged on the traveling base 4. A first upper traveling wheel 9 is arranged at one end of each of the first wheel shaft 6 and the second wheel shaft 7. A second upper traveling wheel 10 is arranged at the other end of each of the first wheel shaft 6 and the second wheel shaft 7. The first upper traveling wheel 9 is located on an upper side of one guide rail 1. The second upper traveling wheel 10 is located on an upper side of the other guide rail 1. Rim structures are arranged on two sides of the first upper traveling wheel 9. The guide rail 1 is located between the rim structures on the two sides of the first upper traveling wheel 9. Lower restraining wheels 12 are arranged on the traveling base 4. The lower restraining wheels 12 are located on lower sides of the two guide rails 1. A traveling drive device 5 is arranged on the traveling base 4 for driving the first wheel shaft 6 and the second wheel shaft 7 to rotate. A rotation drive device 11 is arranged on the traveling base 4. The rotation drive device 11 is connected to the cantilever 2.

In the present disclosure, two guide rails 1 are designed as parallel, in combination with the first wheel shaft 6 and second wheel shaft 7 on the traveling base 4, as well as the first upper traveling wheel 9 and the second upper traveling wheel 10 located on the upper sides of the two guide rails 1 respectively, making a more balanced force distribution on the traveling component. The rim structures on the two sides of the first upper traveling wheel 9 delimit the guide rail 1 therebetween, in combination with the lower restraining wheels 12 located on the lower sides of the two guide rails 1, forming a multi-limitation structure on the guide rails 1 at the upper and lower, and lateral sides. In this way, the stability of the movement of the traveling component is effectively enhanced, and irregular shaking during the movement of the traveling component is considerably reduced. Thus, the operation noise of the apparatus is lowered, the wear of the component is lessened, and the service life of the apparatus is prolonged.

According to the present disclosure, a dual-guide rail 1 support configuration in cooperation with a multi-limitation structure is adopted, considerably enhancing the anti-overturning performance of the traveling component. When the cantilever 2 is subjected to external force disturbances or operating speed changes, this design can effectively resist potential external overturning forces. Thus, the large-amplitude swing of the cantilever 2 is prevented, the stability of cleaning is ensured, the risk of accidental scratches on the vehicle surface is reduced, and the operation safety of the apparatus is substantially improved.

In terms of load-bearing performance, the dual-guide rail structure can distribute loads more effectively, greatly improving the load-bearing performance and enabling the bearing of a heavier washing assembly. The possibility of carrying additional or heavier cleaning assemblies is provided, overcoming the limited load-bearing capacity existing in traditional single-guide rail structures, and thus laying the foundation for the expansion of functions of the vehicle washing machine.

The rotation drive device 11 arranged on the traveling base 4 is connected to the cantilever 2, such that the cantilever 2 can rotate accordingly. In combination with more stable traveling and load-bearing performance, the vehicle washing machine is allowed to adjust the angle and position of the cantilever 2 more flexibly during cleaning operations. This further expands the functions of the vehicle washing machine, enabling it to better adapt to different vehicle models and cleaning scenarios, thereby enhancing cleaning efficiency and effect.

Considering that in practical mounting, the two guide rails 1 of the dual-guide rail structure is difficult to maintain perfect parallelism, and certain mounting errors exist, resulting in an angular deviation between the two guide rails 1. Based on the above problems, in the present disclosure, the traveling wheel (the first upper traveling wheel 9) located on one side of the traveling base 4 is provided with a rim structure, while the traveling wheel (the second upper traveling wheel 10) located on the other side of the traveling base 4 is provided with no rim structure. The first upper traveling wheel 9 with a rim structure accurately moves in a length direction of one guide rail 1, while the second upper traveling wheel 10 with no rim structure is allowed to have a certain lateral deviation relative to the other guide rail 1 during movement. Thus, a “rigid guide” mode is formed between one side of the traveling component and the guide rail 1, and a “flexible adaptation” mode is formed on the other side of the traveling component and the guide rail 1. Stable support and accurate guidance by the dual-guide rail 1 structure on the traveling component are retained. Moreover, the stress induced by the mounting tolerance can be offset by releasing a lateral constraint on one side, and operation obstructions caused by insufficient mounting precision of the guide rails 1 are prevented, such that the traveling component can smoothly move. According to the present disclosure, both structural stability and motion fluency are taken into account, and the adaptability of the traveling component to the mounting tolerance is improved.

The traveling drive device 5 is a speed-reduction electric motor. The first wheel shaft 6 is connected to the speed-reduction electric motor. The first wheel shaft 6 is connected to the second wheel shaft 7 by a synchronous belt 8.

A protective cover 3 is arranged on an outer side of the traveling component to protect the traveling component.

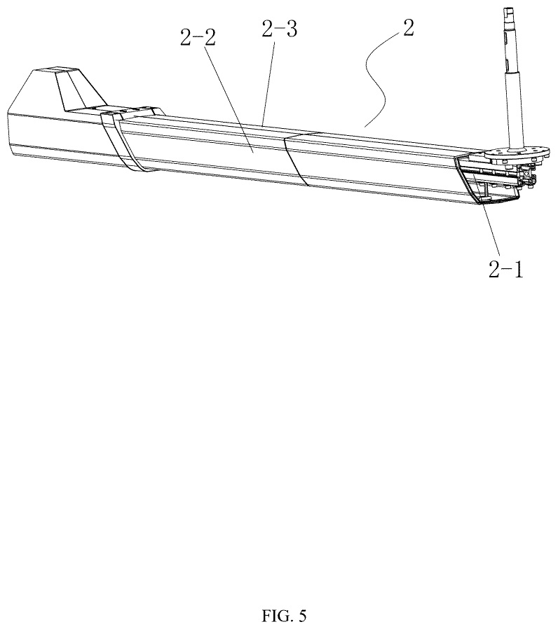

As shown in FIG. 5 to FIG. 9, the cantilever 2 includes a supporting framework 2-1. A housing is arranged on an outer side of the supporting framework 2-1. One end of the supporting framework 2-1 is connected to the rotation drive device 11. A passing space for a cable and a pipeline to pass through is formed between the housing and the supporting framework 2-1. The cleaning assembly is arranged at an end portion of the cantilever 2. The cable for supplying power for the cleaning assembly and the pipeline for supplying water for the cleaning assembly pass through the passing space between the housing and the supporting framework 2-1. In this way, a concealed design of the cable and the pipeline is achieved, improving the simplicity of the appearance of the cantilever 2 while also protecting the cable and the pipeline to a certain degree.

The housing includes a first housing assembly 2-2 and a second housing assembly 2-3. The first housing assembly 2-2 is connected to the second housing assembly 2-3 by a snap-fit mechanism. Connecting portions 2-2a are arranged on an upper side and a lower side of the first housing assembly 2-2. Connecting holes are provided on the connecting portions 2-2a. The connecting portions 2-2a are connected to the supporting framework 2-1 by connecting bolts 2-4. The connecting portions 2-2a on the upper side and the lower side of the first housing assembly 2-2 are fixed to the supporting framework 2-1 by connecting bolts 2-4, such that a vertically symmetrical stressed structure is formed, and the housing is more firmly and reliably connected to the supporting framework 2-1. When the cantilever 2 rotates or moves, the impact force caused by inertia or an external force can be effectively resisted, preventing the housing from loosening or shaking, and thereby ensuring the stability of the entire structure of the cantilever 2. Compared with conventional bolt connection and other manners, the connection between the first housing assembly 2-2 and the second housing assembly 2-3 by the snap-fit mechanism allows for rapid assembly and disassembly of the housing without the need for tools. This significantly reduces operational time during apparatus mounting, internal component servicing, or cable and pipeline maintenance, thereby improving work efficiency and lowering maintenance costs.

The snap-fit mechanism includes a first snap-fit body 2-2b arranged on the first housing assembly 2-2, and a second snap-fit body 2-3a arranged on the second housing assembly 2-3 and corresponding to the first snap-fit body 2-2b.

In this embodiment, the supporting framework 2-1 is made of an aluminum profile, and the housing is made of plastic.

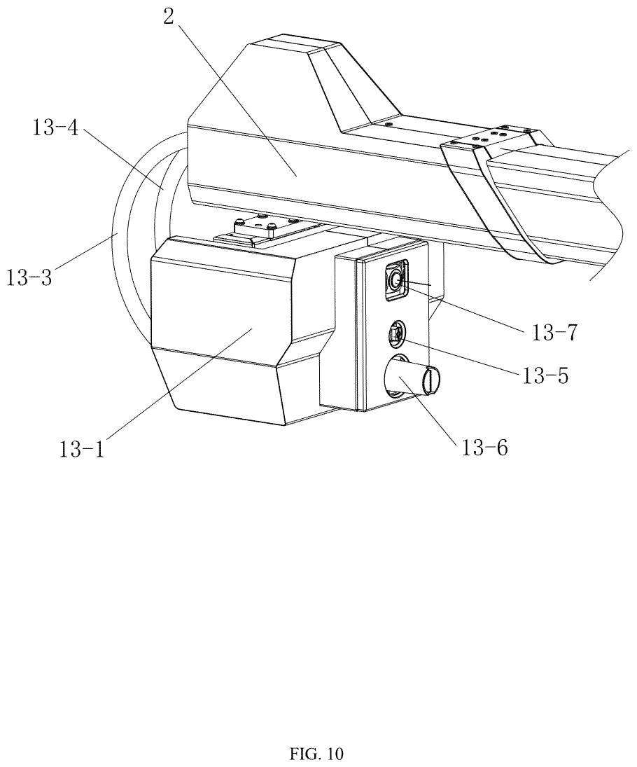

The nozzle component 13 is mounted on an end portion of the cantilever 2. As shown in FIG. 10 to FIG. 15, the nozzle component includes a horizontal rotation drive device 13-8, a water nozzle 13-5, and a detergent nozzle 13-6. A horizontal rotation frame 13-10 is connected to the horizontal rotation drive device 13-8. A pitch drive electric motor 13-12 is arranged on the horizontal rotation frame 13-10. A pitch shaft 13-13 is arranged on the pitch drive electric motor 13-12. A first pitch frame assembly 13-14 and a second pitch frame assembly 13-15 are arranged on the pitch shaft 13-13. An electrically-controlled switching valve 13-11 is arranged on the first pitch frame assembly 13-14. An output end of the electrically-controlled switching valve 13-11 is connected to a first water outlet pipe 13-24 and a second water outlet pipe 13-25. A water nozzle support 13-19 is arranged on the second pitch frame assembly 13-15. A second hoop 13-20 for fixing the water nozzle 13-5 is arranged on the water nozzle support 13-19. The water nozzle 13-5 is connected to the first water outlet pipe 13-24. A detergent nozzle supporting plate 13-21 is arranged on the water nozzle support 13-19. A snap-fit groove is arranged on the detergent nozzle supporting plate 13-21. A protruding portion 13-26 is arranged on an outer side of the detergent nozzle 13-6, and is snap-fitted into the snap-fit groove of the detergent nozzle supporting plate 13-21. One end of the detergent nozzle 13-6 is connected to the second water outlet pipe 13-25. The second water outlet pipe 13-25 is a rigid pipe.

In the present disclosure, through the cooperation between the horizontal rotation drive device 13-8 and the pitch drive electric motor 13-12, the water nozzle 13-5 and the detergent nozzle 13-6 can perform horizontal rotation and pitch actions, thereby covering all parts of the vehicle body and ensuring complete cleaning without missed areas. Moreover, by arranging the electrically-controlled switching valve 13-11, the water nozzle 13-5 and the detergent nozzle 13-6 can be rapidly switched as required, improving cleaning efficiency and quality.

The water nozzle 13-5 is fixed by a hoop. Through such a hoop fixation manner, the mounting and disassembly of the water nozzle 13-5 are simplified, and difficulties in maintenance and replacement are reduced. Meanwhile, loosening or falling-off problems caused by long-time use are effectively prevented, ensuring the stable operation of the nozzle component. For the detergent nozzle 13-6, a snap-fit design is adopted, where the protruding portion 13-26 on the outer side is snap-fitted into the snap-fit groove of the supporting plate. In combination with the stable connection with the rigid second water outlet pipe 13-25, this design enables the rapid positioning and fixation of the detergent nozzle 13-6. During disassembly, it is only required to perform disconnection from the second water outlet pipe 13-25 and release the snap-fit state with the detergent nozzle supporting plate 13-21. Thus, both mounting and disassembly are relatively convenient.

According to the present disclosure, the convenience of mounting and disassembly of the water nozzle 13-5 and the detergent nozzle 13-6 is fully considered. The water nozzle 13-5 is fixedly mounted by the hoop, and the detergent nozzle 13-6 is fixedly mounted by the rigid second water outlet pipe 13-25 in combination with a snap-fit groove connection. Thus, the mounting and disassembly of the water nozzle 13-5 and the detergent nozzle 13-6 are greatly facilitated, and difficulties in maintenance and replacement of the nozzles are reduced.

A camera 13-7 is arranged on the second pitch frame assembly 13-15. By mounting the camera 13-7, the working state of the nozzles can be monitored in real time. The camera 13-7 sends live images of the washing process to background staff, enabling timely detection of potential issues such as nozzle clogging, abnormal water/foam spraying, or angular deviation. Once an abnormal situation is found, it can be fed back to the control system in time, and the operator can rapidly identify and process the issue. This helps minimize reductions in cleaning quality or apparatus damage caused by nozzle malfunctions, thereby enhancing the reliability and stability of the apparatus. In addition, through real-time monitoring by the camera 13-7, whether a foreign object enters the cleaning area or whether the vehicle unexpectedly moves during the washing process can be detected. Once an abnormal situation is detected, background staff can pause the vehicle washing machine to prevent collisions between the apparatus and the vehicle or the foreign object, such that the safety of the apparatus and the vehicle is ensured.

A camera mounting seat 13-22 for mounting the camera 13-7 is arranged on the second pitch frame assembly 13-15. The camera 13-7 is mounted on and connected to the camera mounting seat 13-22 by a screw, such that the camera 13-7 can be conveniently disassembled.

A first hoop 13-16 and an electrically-controlled switching valve fixing support 13-17 are arranged on the first pitch frame assembly 13-14. The electrically-controlled switching valve 13-11 is connected to the first hoop 13-16. The electrically-controlled switching valve 13-11 is connected to the electrically-controlled switching valve fixing support 13-17 by a screw. The electrically-controlled switching valve fixing support 13-17 is fixedly connected to the first hoop 13-16. The first hoop 13-16 is connected to the first pitch frame assembly by a connecting column 13-18. The first hoop 13-16 radially restrains the electrically-controlled switching valve 13-11 through an encircling structure, such that the pulse impact force generated during water flow switching can be effectively offset, and loosening of the valve caused by high-frequency vibrations is prevented. The electrically-controlled switching valve fixing support 13-17 connected to the valve by a screw provides axial rigid support, and forms a three-dimensional fixing system together with the first hoop 13-16. Thus, the valve body always maintains positional stability during horizontal rotation and pitch movements.

In this embodiment, the electrically-controlled switching valve fixing support 13-17 is L-shaped.

The output end of the electrically-controlled switching valve 13-11 is connected to a water inlet pipe 13-9. The water inlet pipe 13-9 is connected to a water supply pipe 13-3. A detergent connector 13-27 is arranged on a side of the detergent nozzle 13-6. The detergent connector 13-27 is connected to a detergent pipe 13-4. When the electrically-controlled switching valve 13-11 is switched to a state where the detergent nozzle 13-6 is opened, water is sprayed through the detergent nozzle 13-6, while the detergent enters the detergent nozzle 13-6 through the detergent connector 13-27, and the detergent and the water are mixed to form foam to be sprayed out from the detergent nozzle 13-6.

In this embodiment, the snap-fit groove is a U-shaped groove. An opening of the snap-fit groove faces a front side of the detergent nozzle 6. Two side walls of the U-shaped groove impose lateral constraints on the protruding portion 13-26 of the nozzle. In combination with the rigid support by the second water outlet pipe 13-25, shaking of the nozzle in both horizontal vertical directions can be effectively limited. Moreover, with the opening of the snap-fit groove facing the front side of the nozzle, i.e., aligned with a water spraying direction, the protruding portion 13-26 can be more tightly against a bottom of the snap-fit groove under a reactive force generated by the water flow impact. The stability of the connection is further enhanced.

The second water outlet pipe 13-25 is a rigid pipe made of stainless steel or other metallic materials.

The present disclosure is not limited to the above optimum implementations. Anyone can obtain other products in various forms under the inspiration of the present disclosure. However, no matter what change is made in its shape or structure, any technical solution identical or similar to that of the present disclosure falls within the scope of protection of the present disclosure.

1. A vehicle washing machine, comprising a traveling cantilever device and a nozzle component mounted on the traveling cantilever device, wherein the nozzle component comprises a horizontal rotation drive device, a water nozzle, and a detergent nozzle; a horizontal rotation frame is connected to the horizontal rotation drive device, a pitch drive electric motor is arranged on the horizontal rotation frame, a pitch shaft is arranged on the pitch drive electric motor, and a first pitch frame assembly and a second pitch frame assembly are arranged on the pitch shaft; an electrically-controlled switching valve is arranged on the first pitch frame assembly, and an output end of the electrically-controlled switching valve is connected to a first water outlet pipe and a second water outlet pipe; a water nozzle support is arranged on the second pitch frame assembly, a second hoop for fixing the water nozzle is arranged on the water nozzle support, and the water nozzle is connected to the first water outlet pipe; a detergent nozzle supporting plate is arranged on the water nozzle support, a snap-fit groove is arranged on the detergent nozzle supporting plate, and a protruding portion is arranged on an outer side of the detergent nozzle, and is snap-fitted into the snap-fit groove on the detergent nozzle supporting plate; and one end of the detergent nozzle is connected to the second water outlet pipe, and the second water outlet pipe is a rigid pipe.

2. The vehicle washing machine according to claim 1, wherein a camera is arranged on the second pitch frame assembly.

3. The vehicle washing machine according to claim 2, wherein a camera mounting seat for mounting the camera is arranged on the second pitch frame assembly, and the camera is mounted on and connected to the camera mounting seat by a screw.

4. The vehicle washing machine according to claim 1, wherein a first hoop and an electrically-controlled switching valve fixing support are arranged on the first pitch frame assembly, the electrically-controlled switching valve is connected to the first hoop, and the electrically-controlled switching valve is connected to the electrically-controlled switching valve fixing support by a screw.

5. The vehicle washing machine according to claim 1, wherein the output end of the electrically-controlled switching valve is connected to a water inlet pipe, the water inlet pipe is connected to a water supply pipe, a detergent connector is arranged on a side of the detergent nozzle, and the detergent connector is connected to a detergent pipe.

6. The vehicle washing machine according to claim 1, wherein the snap-fit groove is a U-shaped groove, and an opening of the snap-fit groove faces a front side of the detergent nozzle.

7. The vehicle washing machine according to claim 1, wherein the traveling cantilever device comprises two parallel guide rails, a traveling component mounted on the two guide rails, and a cantilever; the traveling component comprises a traveling base, a first wheel shaft and a second wheel shaft are arranged on the traveling base, a first upper traveling wheel is arranged at one end of each of the first wheel shaft and the second wheel shaft, a second upper traveling wheel is arranged at the other end of each of the first wheel shaft and the second wheel shaft, the first upper traveling wheel is located on an upper side of one guide rail, and the second upper traveling wheel is located on an upper side of the other guide rail; rim structures are arranged on two sides of the first upper traveling wheel, and the guide rail is located between the rim structures on the two sides of the first upper traveling wheel; lower restraining wheels are arranged on the traveling base, and the lower restraining wheels are located on lower sides of the two guide rails; a traveling drive device is arranged on the traveling base for driving the first wheel shaft and the second wheel shaft to rotate; a rotation drive device is arranged on the traveling base, and the rotation drive device is connected to the cantilever; and the nozzle component is arranged at an end portion of the cantilever.

8. The vehicle washing machine according to claim 7, wherein the traveling drive device is a speed-reduction electric motor, the first wheel shaft is connected to the speed-reduction electric motor, and the first wheel shaft is connected to the second wheel shaft by a synchronous belt.

9. The vehicle washing machine according to claim 7, wherein the cantilever comprises a supporting framework, a housing is arranged on an outer side of the supporting framework, one end of the supporting framework is connected to the rotation drive device, and a passing space for a cable and a pipeline to pass through is formed between the housing and the supporting framework.

10. The vehicle washing machine according to claim 9, wherein the housing comprises a first housing assembly and a second housing assembly, and the first housing assembly is connected to the second housing assembly by a snap-fit mechanism; and connecting portions are arranged on an upper side and a lower side of the first housing assembly, connecting holes are provided on the connecting portions, and the connecting portions are connected to the supporting framework by connecting bolts.
